(19) United States
(12) Patent Application Publication
(10) Pub. No.: US 2026/0351747 A1
(43) Pub. Date: Nov. 5, 2026

(54) Pouch Cell and Battery Assembly

(71) Applicant: ZHEJIANG LIWINON ENERGY TECHNOLOGY CO., LTD., Jinhua (CN)

(72) Inventors: Zhen Yuan, Jinhua (CN); Dongfang Qi, Jinhua (CN); Bing Han, Jinhua (CN); Cong Li, Jinhua (CN); Rongjin Ji, Jinhua (CN); Shengben Wu, Jinhua (CN); Jie Chen, Jinhua (CN)

(21) Appl. No.: 19/725,246

(22) Filed: Jun. 30, 2026

Related U.S. Application Data
(63) Continuation of application No. PCT/CN2024/140074, filed on Dec. 17, 2024.

(30) Foreign Application Priority Data
Nov. 8, 2024 (CN) 202422725534.2

(51) Int. Cl. H01M 50/178; H01M 10/42; H01M 50/105; H01M 50/191; H01M 50/197

(52) U.S. Cl. CPC H01M 50/178; H01M 10/425; H01M 50/105; H01M 50/191; H01M 50/197

(57) ABSTRACT

A pouch cell includes a casing, an electrode assembly, and a plurality of tabs. The casing includes a package body with an accommodating cavity, and a top sealing edge including a sealed portion and an unsealed portion. The sealed portion is connected to the package body. The unsealed portion is connected to the sealed portion, and includes a first unsealed sub-portion and a second unsealed sub-portion. The first unsealed sub-portion is provided with a clearance groove. The tabs are connected to the electrode assembly, and extend out of the accommodating cavity. A portion of each of the tabs located outside the first unsealed sub-portion and the second unsealed sub-portion is a first tab portion. A dimension of the first tab portion in a length direction of the top sealing edge is not greater than a dimension of the clearance groove in the length direction of the top sealing edge.

### CROSS-REFERENCE TO RELATED APPLICATIONS

This application is a bypass continuation application of International Patent Application No. PCT/CN2024/140074, filed Dec. 17, 2024, which claims priority to Chinese Patent Application No. 202422725534.2 filed Nov. 8, 2024, the disclosures of which are hereby incorporated by reference in their entireties.

### BACKGROUND

### Technical Field

The present disclosure relates to the field of battery technologies, and specifically to a pouch cell and a battery assembly.

### Technical Considerations

In some technologies, to prevent sealant from overflowing during the edge sealing of a pouch cell, an unsealed area is reserved outside the sealing edge to accommodate the sealant that overflows from the sealing edge. To improve the energy density of the pouch cell, the tabs are bent toward the casing during installation to reduce the length of the pouch cell. However, after the aluminum-plastic film is cut, the aluminum layer inside the aluminum-plastic film is exposed from the cut edge. In order to avoid short circuit due to contact between the tabs and the aluminum layer, the bending of the tabs needs to be staggered from the unsealed portion in the width direction of the top sealing edge, which leads to an increase in the length of the pouch cell and therefore a decrease in the energy density of the pouch cell.

### SUMMARY

The present disclosure aims to resolve at least one of technical problems in the existing technology. Therefore, the present disclosure provides a pouch cell with improved energy density.

The present disclosure further provides a battery assembly including the pouch cell.

In accordance with a first aspect of the present disclosure, an embodiment provides a pouch cell, including a casing, an electrode assembly, and a plurality of tabs.

The casing includes a package body and a top sealing edge. The package body is provided with an accommodating cavity. The top sealing edge includes a sealed portion and an unsealed portion. The sealed portion is connected to the package body. The unsealed portion is connected to a side of the sealed portion facing away from the package body. The unsealed portion includes a first unsealed sub-portion and a second unsealed sub-portion distributed in a thickness direction of the unsealed portion. The first unsealed sub-portion is provided with a clearance groove. The clearance groove extends to a surface of the first unsealed sub-portion facing away from the sealed portion. The electrode assembly is located in the accommodating cavity. The tabs are connected to the electrode assembly, and extend out of the accommodating cavity from between the first unsealed sub-portion and the second unsealed sub-portion. A portion of each of the tabs located outside the first unsealed sub-portion and the second unsealed sub-portion is a first tab portion. A dimension of the first tab portion in a length direction of the top sealing edge is not greater than a dimension of the clearance groove in the length direction of the top sealing edge.

The pouch cell according to the embodiments of the present disclosure at least has the following beneficial effects.

In this embodiment, the first unsealed sub-portion is provided with the clearance groove, and the dimension of the first tab portion in the length direction of the top sealing edge is not greater than the dimension of the clearance groove in the length direction of the top sealing edge. Therefore, when the pouch cell is assembled with other parts, the first tab portion can be bent toward the clearance groove, so that a part of a projection of the first tab portion in the thickness direction of the top sealing edge is located within a range of the clearance groove, thereby reducing the risk of the tab coming into contact with the first unsealed sub-portion during use. It can be understood that compared with the existing technology, in this embodiment, a part of the projection of the first tab portion is located within the range of the clearance groove, i.e., the space occupied by the first tab portion and the space occupied by the unsealed portion in the width direction of the top sealing edge partially overlap, so that the space occupied by the pouch cell is reduced, thereby improving the energy density of the pouch cell.

According to some embodiments of the present disclosure, a portion of each of the tabs between the first unsealed sub-portion and the second unsealed sub-portion is a second tab portion, and a projection of the second tab portion in a thickness direction of the top sealing edge is located within a range of the clearance groove.

According to some embodiments of the present disclosure, the pouch cell further includes a first insulating adhesive layer located in the clearance groove and covering the second tab portion.

According to some embodiments of the present disclosure, the first unsealed sub-portion includes a first insulating layer, a first metal layer, and a second insulating layer adhered to each other in a thickness direction of the first unsealed sub-portion, the first insulating layer is provided with a first notch, the first metal layer is provided with a second notch aligned with the first notch, the clearance groove includes the first notch and the second notch, and a portion of the second insulating layer corresponding to the second notch forms the first insulating adhesive layer.

According to some embodiments of the present disclosure, the second unsealed sub-portion includes a third insulating layer, a second metal layer, and a fourth insulating layer adhered to each other in a thickness direction of the second unsealed sub-portion, the third insulating layer is provided with a third notch at a position corresponding to the second tab portion, the second metal layer is provided with a fourth notch aligned with the third notch, and the fourth insulating layer covers the second tab portion.

According to some embodiments of the present disclosure, the first unsealed sub-portion is provided with a plurality of clearance grooves, the pouch cell includes a plurality of tabs, the plurality of clearance grooves are provided in one-to-one correspondence with the plurality of tabs, a region of the unsealed portion located between neighboring clearance grooves is provided with a fifth notch running therethrough in the thickness direction of the unsealed portion, and the fifth notch extends to an edge of the unsealed portion and extends to the clearance grooves; and

in the length direction of the top sealing edge, two outermost clearance grooves of the plurality of clearance grooves are outer clearance grooves, a region of the unsealed portion extending outward away from each of the two outer clearance grooves is further provided with a sixth notch running therethrough in the thickness direction of the unsealed portion, and each sixth notch extends to the edge of the unsealed portion and extends to the outer clearance grooves adjacent thereto.

According to some embodiments of the present disclosure, a dimension of the unsealed portion in a width direction of the top sealing edge is defined as L₃, a dimension of the clearance groove in the width direction of the top sealing edge is defined as L₄, and 7/8≤L₄/L₃≤9/10.

In accordance with a second aspect of the present disclosure, an embodiment provides a battery assembly, including a circuit board and the pouch cell of the embodiments of the first aspect of the present disclosure. The first tab portion is arranged to be bent toward the top sealing edge and is electrically connected to the circuit board. A part of a projection of the first tab portion in the thickness direction of the top sealing edge is located in the clearance groove.

The battery assembly according to the embodiments of the present disclosure at least has the following beneficial effects.

With the use of the pouch cell of the embodiments of the first aspect, the first unsealed sub-portion is provided with the clearance groove, and the dimension of the first tab portion in the length direction of the top sealing edge is not greater than the dimension of the clearance groove in the length direction of the top sealing edge. The first tab portion is arranged to be bent toward the clearance groove, so that a part of a projection of the first tab portion in the thickness direction of the top sealing edge is located within a range of the clearance groove, thereby reducing the risk of the tab coming into contact with the first unsealed sub-portion during use. It can be understood that compared with the existing technology, in this embodiment, a part of the projection of the first tab portion is located within the range of the clearance groove, i.e., the space occupied by the first tab portion and the space occupied by the unsealed portion in the width direction of the top sealing edge partially overlap, so that the space occupied by the pouch cell is reduced, thereby improving the energy density of the pouch cell and therefore improving the energy density of the battery assembly of this embodiment.

According to some embodiments of the present disclosure, the top sealing edge is arranged to be bent toward the package body, the circuit board includes two connecting surfaces opposite to each other in the length direction of the pouch cell, and the first tab portion is connected to any of the connecting surfaces.

According to some embodiments of the present disclosure, the first tab portion is bent to form a plurality of bending portions.

According to some embodiments of the present disclosure, the first tab portion is spaced apart from a side wall of the clearance groove in a width direction of the top sealing edge.

Additional aspects and advantages of the present disclosure will be partly given in and partly apparent from the description below, or understood through practice of the present disclosure.

### BRIEF DESCRIPTION OF THE DRAWINGS

The present disclosure will be further described below with reference to the accompanying drawings and embodiments. In the drawings:

FIG. 1 is a schematic structural diagram of a conventional battery assembly in the existing technology;

FIG. 2 is a schematic structural diagram of a pouch cell according to an embodiment of a first aspect of the present disclosure;

FIG. 3 is a schematic enlarged view of part A in FIG. 2;

FIG. 4 is a schematic structural diagram of the pouch cell shown in FIG. 2 after tabs are bent;

FIG. 5 is a schematic enlarged view of part B in FIG. 4;

FIG. 6 is a schematic structural diagram of a second pouch cell according to an embodiment of the first aspect of the present disclosure;

FIG. 7 is a schematic structural diagram of a third pouch cell according to an embodiment of the first aspect of the present disclosure;

FIG. 8 is a partial cross-sectional view of the pouch cell in FIG. 4;

FIG. 9 is a schematic enlarged view of part C in FIG. 8;

FIG. 10 is a schematic structural diagram of a fourth pouch cell according to an embodiment of the first aspect of the present disclosure;

FIG. 11 is a schematic structural diagram of a first battery assembly according to an embodiment of a second aspect of the present disclosure;

FIG. 12 is a schematic structural diagram of a second battery assembly according to an embodiment of the second aspect of the present disclosure;

FIG. 13 is a schematic structural diagram of a third battery assembly according to an embodiment of the second aspect of the present disclosure; and

FIG. 14 is a schematic structural diagram of a pouch cell showing an electrode assembly and an accommodating cavity according to an embodiment of the first aspect of the present disclosure.

### LIST OF REFERENCE NUMERALS

casing 100; package body 110; top sealing edge 101; sealed portion 120; unsealed portion 130; first unsealed sub-portion 131; clearance groove 1301; fifth notch 1302; sixth notch 1303; first insulating layer 1311; first notch 13111; first metal layer 1312; second notch 13121; second insulating layer 1313; second unsealed sub-portion 132; third insulating layer 1321; third notch 13211; second metal layer 1322; fourth notch 13221; fourth insulating layer 1323;
tab 200; first tab portion 210; bending portion 211; second tab portion 220;
first insulating adhesive layer 300; second insulating adhesive layer 400; circuit board 500;
electrode assembly 600, accommodating cavity 700.

### DETAILED DESCRIPTION

Embodiments of the present disclosure will be described in detail hereinafter in conjunction with accompanying drawings in which the same or like reference numerals refer to the same or like elements or elements having the same or like functions throughout. The embodiments described below by reference to the accompanying drawings are illustrative and are intended for illustrating only and are not to be construed as limiting the present disclosure.

In the description of the present disclosure, it should be understood that for the description of orientations, the orientation or positional relationships indicated by the terms such as “up,” “down,” “front,” “rear,” “left,” “right” and the like are based on orientation or positional relationships shown in the accompanying drawings, and are used only for ease and brevity of illustration and description, rather than indicating or implying that the mentioned apparatus or element must have a particular orientation or must be constructed and operated in a particular orientation. Therefore, such terms should not be construed as limiting of the present disclosure.

In the description of the present disclosure, the term “at least one” means one or more, the term “plurality of/multiple” means two or more, the term such as “greater than,” “less than,” “exceed” or variants thereof prior to a number or series of numbers is understood to not include the number adjacent to the term. The term such as “above,” “below,” “within,” etc., are understood to include the number adjacent to the term. If used herein, the terms such as “first,” “second,” and the like are merely used for distinguishing technical features, and are not intended to indicate or imply relative importance, or implicitly point out the number of the indicated technical features, or implicitly point out the precedence order of the indicated technical features.

In the description of the present disclosure, unless otherwise explicitly defined, the terms such as “configure,” “install/mount” and “connect” should be understood in a broad sense, and those having ordinary skills in the art can reasonably determine the specific meanings of the above terms in the present disclosure based on the specific contents of the technical scheme.

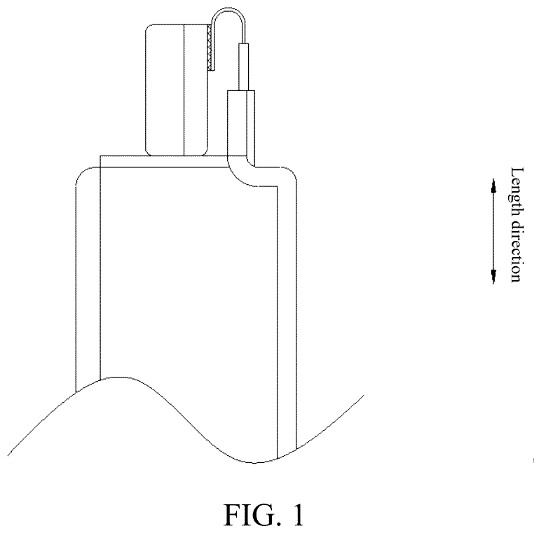

In some technologies, to prevent sealant from overflowing during the edge sealing of a pouch cell, an unsealed area is reserved outside the sealing edge to accommodate the sealant that overflows from the sealing edge. To improve the energy density of the pouch cell, the tabs are bent toward the casing during installation to reduce the length of the pouch cell. However, after the aluminum-plastic film is cut, the aluminum layer inside the aluminum-plastic film is exposed from the cut edge. In order to avoid short circuit due to contact between the tabs and the aluminum layer, the bending of the tabs needs to be staggered from the unsealed portion in the width direction of the top sealing edge (as shown in FIG. 1), which leads to an increase in the length of the pouch cell and therefore a decrease in the energy density of the pouch cell.

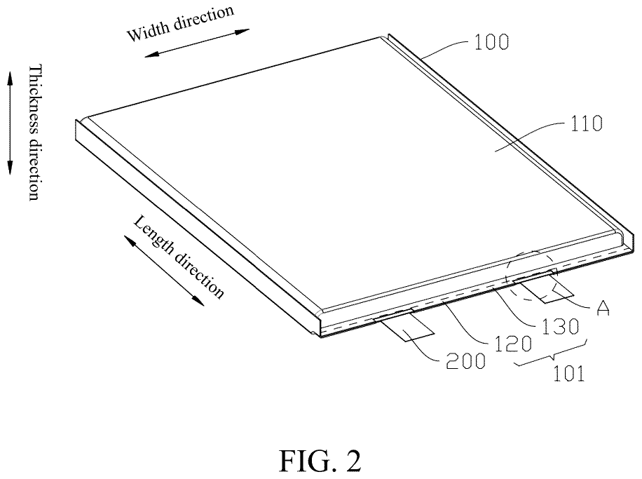

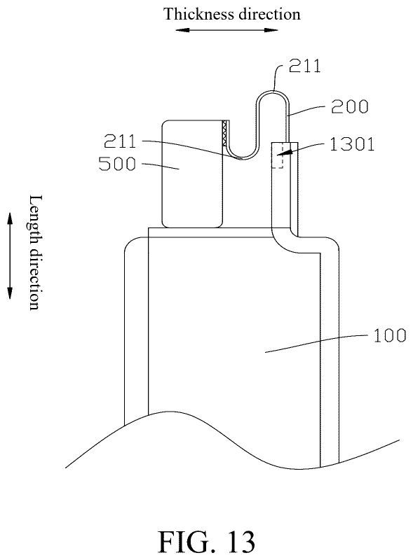

In view of the above, embodiments of a first aspect of the present disclosure provide a pouch cell with improved energy density. The embodiments of the present disclosure will be described with reference to FIG. 2 to FIG. 13. It should be noted that in the drawings, “Length direction” is a length direction of the pouch cell, “Width direction” is a length direction of a top sealing edge, and “Thickness direction” is a thickness direction of the pouch cell. In the following description, the width direction of the top sealing edge corresponds to the length direction of the pouch cell when the top sealing edge is not folded, the thickness direction of the top sealing edge corresponds to the thickness direction of the pouch cell when the top sealing edge is not folded, and the length direction of the top sealing edge corresponds to a width direction of the pouch cell.

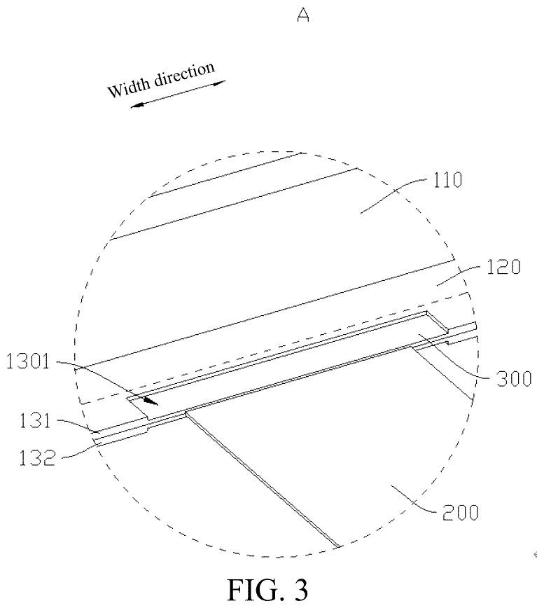

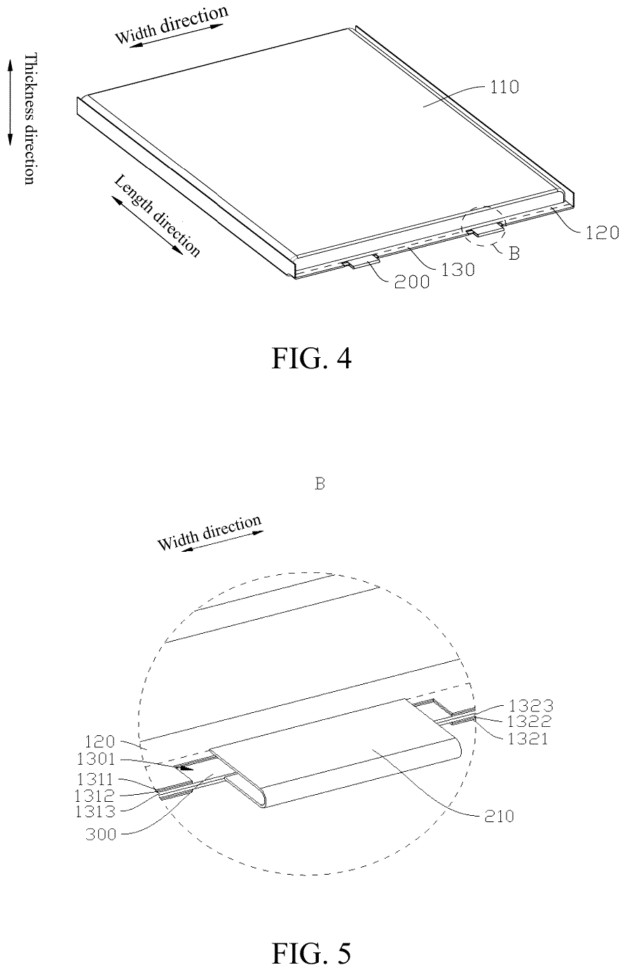

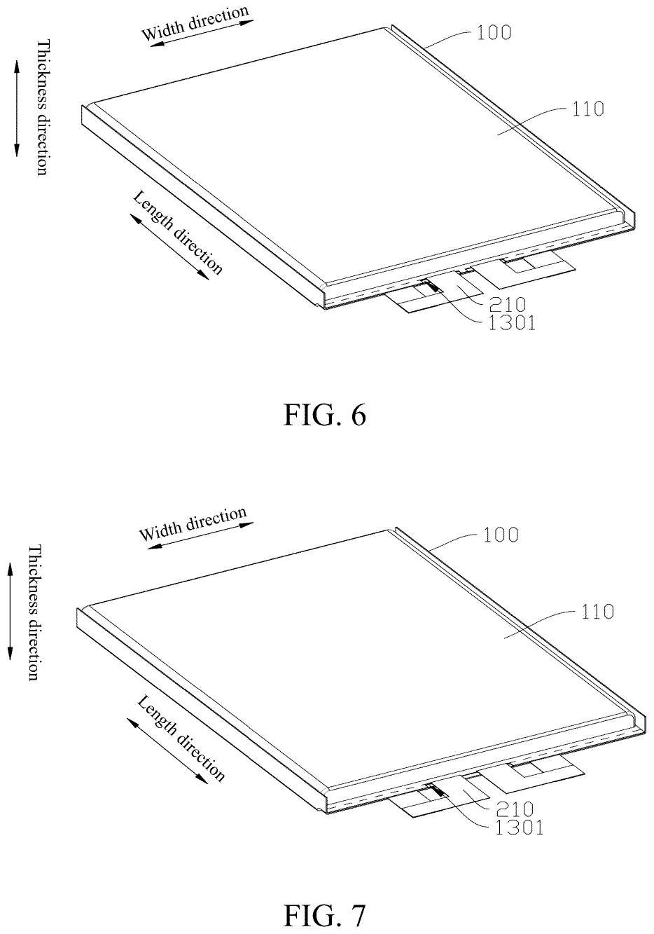

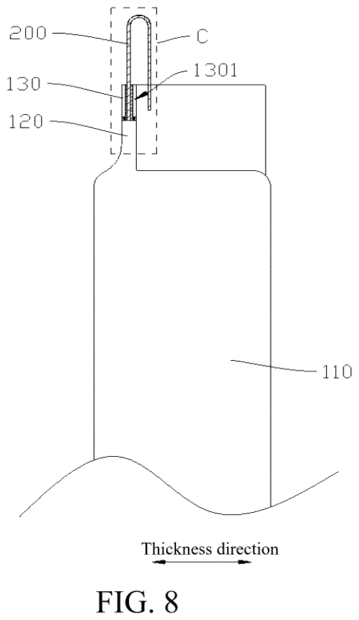

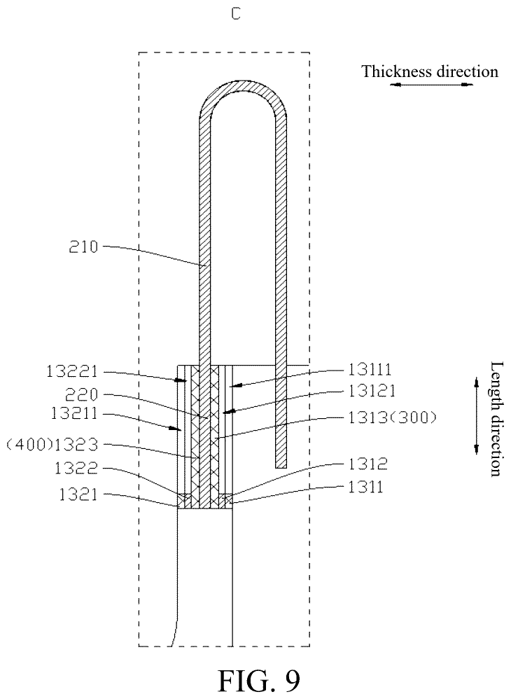

Refer to FIG. 2 to FIG. 9 and FIG. 14. FIG. 2 is a schematic structural diagram of a pouch cell according to an embodiment of a first aspect of the present disclosure. FIG. 3 is a schematic enlarged view of part A in FIG. 2. FIG. 4 is a schematic structural diagram of the pouch cell shown in FIG. 2 after tabs are bent. FIG. 5 is a schematic enlarged view of part B in FIG. 4. FIG. 6 is a schematic structural diagram of a second pouch cell according to an embodiment of the first aspect of the present disclosure. FIG. 7 is a schematic structural diagram of a third pouch cell according to an embodiment of the first aspect of the present disclosure. FIG. 8 is a partial cross-sectional view of the pouch cell in FIG. 4. FIG. 9 is a schematic enlarged view of part C in FIG. 8. The pouch cell of this embodiment includes a casing 100, an electrode assembly 600, and a plurality of tabs 200.

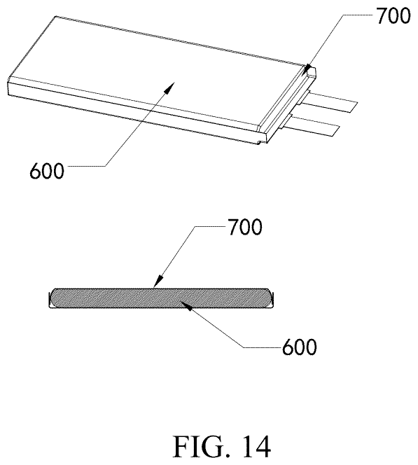

The casing 100 is formed by, for example, folding an aluminum-plastic film in half and sealing the aluminum-plastic film. However, the present disclosure is not limited thereto, and the casing 100 may also be made of a composite material including a metal layer and a non-metal layer. Unless otherwise specified, the aluminum-plastic film is used as an example for description in the present disclosure. The casing 100 includes a package body 110 and a top sealing edge 101. The top sealing edge 101 includes a sealed portion 120 and an unsealed portion 130 (as shown in FIG. 3). The package body 110 is provided with an accommodating cavity 700 (as shown in FIG. 14). The sealed portion 120 is connected to the package body 110. The unsealed portion 130 is connected to a side of the sealed portion 120 facing away from the package body 110. The unsealed portion 130 includes a first unsealed sub-portion 131 and a second unsealed sub-portion 132 distributed in a thickness direction thereof. The first unsealed sub-portion 131 is provided with a clearance groove 1301. The clearance groove 1301 extends to a surface of the first unsealed sub-portion 131 facing away from the sealed portion 120. The electrode assembly 600 is located in the accommodating cavity 700. The tabs 200 are connected to the electrode assembly 600, and extend out of the accommodating cavity 700 from between the first unsealed sub-portion 131 and the second unsealed sub-portion 132. A portion of each of the tabs 200 located outside the first unsealed sub-portion 131 and the second unsealed sub-portion 132 is a first tab portion 210. A dimension of the first tab portion 210 in a length direction of the top sealing edge 101 is not greater than a dimension of the clearance groove 1301 in the length direction of the top sealing edge. For example, in the length direction of the top sealing edge 101, a dimension of each first tab portion 210 is defined as L₁, a dimension of each clearance groove 1301 is defined as L₂, and 0<L₂−L₁≤2mm.

When the pouch cell is assembled with other parts, the first tab portion 210 can be bent toward the clearance groove 1301 (as shown in FIG. 5), so that a part of a projection of the first tab portion 210 in the thickness direction of the top sealing edge 101 is located within a range of the clearance groove 1301 (as shown in FIG. 8 and FIG. 9), thereby reducing the risk of the tab 200 coming into contact with the first unsealed sub-portion 131 during use. It can be understood that compared with the existing technology, in this embodiment, a part of the projection of the first tab portion 210 is located within the range of the clearance groove 1301, i.e., the space occupied by the first tab portion 210 and the space occupied by the unsealed portion 130 in the width direction of the top sealing edge 101 partially overlap, so that the space occupied by the pouch cell is reduced. For example, when the top sealing edge 101 is not folded, the space occupied by the first tab portion 210 and the space occupied by the unsealed portion 130 in the width direction of the top sealing edge 101 partially overlap, so that the space occupied by the pouch cell in the length direction of the pouch cell can be reduced. When the top sealing edge 101 is bent toward the package body 110 so that the width direction of the top sealing edge 101 corresponds to the thickness direction of the pouch cell, the space occupied by the pouch cell in the thickness direction of the pouch cell can be reduced, so that the energy density of the pouch cell can be improved.

It should be noted that dashed straight lines in FIG. 2 to FIG. 5 are not to be construed as an actual contour line of the pouch cell, and is merely used for clearly showing the positions of the sealed portion 120 and the unsealed portion 130. Moreover, in this embodiment, the number of the clearance grooves 1301 is not limited, and may be one, two, or more as required. A pouch cell typically includes at least two tabs 200. For small-sized pouch cells, since the distance between the two tabs 200 is relatively small, only one clearance groove 1301 can be provided on the first unsealed sub-portion 131 (as shown in FIG. 7), i.e., one clearance groove 1301 corresponds to the two tabs 200. For large-sized pouch cells, since the distance between the two tabs 200 is relatively large, two clearance grooves 1301 can be provided on the first unsealed sub-portion 131, i.e., one tab 200 corresponds to one clearance groove 1301. For pouch cells with a plurality of tabs 200, a plurality of clearance grooves 1301 may be provided correspondingly. Further, in this embodiment, the position of the clearance groove 1301 is not limited. For example, when only one clearance groove 1301 is provided, the clearance groove 1301 may be located between the two tabs 200 (as shown in FIG. 6), or the clearance groove 1301 may be provided at an edge of the first unsealed sub-portion 131 in the length direction of the top sealing edge 101 according to installation requirements of the pouch cell, and then the tabs 200 may be bent toward the clearance groove 1301 by using the flexibility of the tabs 200, so that the tabs 200 are arranged to be bent toward the clearance groove 1301.

It should also be noted that a part of the projection of the first tab portion 210 being located within the range of the clearance groove 1301 includes a case where a part of the first tab portion 210 extends into the clearance groove 1301 and a case where the first tab portion 210 is located outside the clearance groove 1301, which may be determined according to usage requirements.

In addition, the relative positional relationship between the first unsealed sub-portion 131 and the second unsealed sub-portion 132 in the drawings are not to be interpreted as limiting this embodiment, and any positional relationship is possible as long as the first unsealed sub-portion 131 and the second unsealed sub-portion 132 are distributed in a thickness direction of the unsealed portion 130.

Referring to FIG. 8 and FIG. 9, in some embodiments, a portion of each of the tabs 200 between the first unsealed sub-portion 131 and the second unsealed sub-portion 132 is a second tab portion 220, and a projection of the second tab portion 220 in the thickness direction of the top sealing edge 101 is located within the range of the clearance groove 1301, i.e., the position of the clearance groove 1301 corresponds to the position where the tab 200 extends out. Therefore, when the tab 200 is bent, the tab 200 can be bent by a crease extending in its own width direction, so that the space occupied by the tab 200 in the width direction of the pouch cell can be reduced, and the energy density of the pouch cell can be improved.

Referring to FIG. 5, in some embodiments, the pouch cell further includes a first insulating adhesive layer 300, and the first insulating adhesive layer 300 is located in the clearance groove 1301 and covers the second tab portion 220. As can be learned from the above, after the aluminum-plastic film is cut, the aluminum layer inside the aluminum-plastic film is exposed from the cut edge, i.e., in this embodiment, the aluminum layer is exposed from an inner wall of the clearance groove 1301. To improve the safety of the pouch cell, the pouch cell of this embodiment further includes a first insulating adhesive layer 300, and the first insulating adhesive layer 300 is located in the clearance groove 1301 and covers the second tab portion 220, to prevent the aluminum layer exposed from the inner wall of the clearance groove 1301 from coming into contact with the tab 200.

Referring to FIG. 5 to FIG. 9, in some embodiments, the first unsealed sub-portion 131 includes a first insulating layer 1311, a first metal layer 1312, and a second insulating layer 1313 adhered to each other in a thickness direction thereof. For example, the casing 100 of this embodiment is made of an aluminum-plastic film, the first insulating layer 1311 is made of an insulating material such as a nylon layer or a polyethylene terephthalate (PET) layer, the first metal layer 1312 is an aluminum layer, and the second insulating layer 1313 is a polypropylene (PP) layer. The first insulating layer 1311 is provided with a first notch 13111. The first metal layer 1312 is provided with a second notch 13121 aligned with the first notch 13111 (as shown in FIG. 9). The clearance groove 1301 includes the first notch 13111 and the second notch 13121. A portion of the second insulating layer 1313 corresponding to the second notch 13121 forms the first insulating adhesive layer 300. In other words, during production, the first notch 13111 and the second notch 13121 are respectively formed on the nylon layer and the aluminum layer of the aluminum-plastic film, and the PP layer at the position corresponding to the first notch 13111 and the second notch 13121 is retained as the first insulating adhesive layer 300. As such, it is not necessary to use another component as the first insulating adhesive layer 300, so that the production costs of the pouch cell can be reduced. In addition, because the operation of forming the first insulating adhesive layer 300 is omitted, the production efficiency of the pouch cell can be improved.

Referring to FIG. 8 and FIG. 9, based on the above embodiments, the second unsealed sub-portion 132 includes a third insulating layer 1321, a second metal layer 1322, and a fourth insulating layer 1323 adhered to each other in a thickness direction thereof. Similarly, taking the casing 100 made of an aluminum-plastic film as an example, the third insulating layer 1321 is made of an insulating material such as a nylon layer or a PET layer. The second metal layer 1322 is an aluminum layer. The fourth insulating layer 1323 is a PP layer. The third insulating layer 1321 is provided with a third notch 13211 at a position corresponding to the second tab portion 220. The second metal layer 1322 is provided with a fourth notch 13221 aligned with the third notch 13211. The fourth insulating layer 1323 covers the second tab portion 220. A portion of the fourth insulating layer 1323 corresponding to the second tab portion 220 is defined as a second insulating adhesive layer 400. The second insulating adhesive layer 400 covers a position of the second tab portion 220 corresponding to the second notch 13121, to avoid short circuit due to contact between the tab 200 and the second metal layer 1322, thereby improving safety during use of the pouch cell. In this embodiment, a part of the fourth insulating layer 1323 is used as the second insulating adhesive layer 400. Taking an aluminum-plastic film as an example, in this embodiment, a part of the PP layer is used as the second insulating adhesive layer 400, and it is not necessary to provide another insulating adhesive (e.g., in the existing technology, a tab adhesive protruding from the unsealed portion 130 needs to be provided at the position where the tab 200 extends out), so that the production costs of the pouch cell can be reduced. In addition, because the operation of forming the tab adhesive is omitted, the production efficiency of the pouch cell can be improved.

In addition, it can be understood that in this embodiment, because it is not necessary to provide the tab adhesive protruding from the unsealed portion 130 as in the existing technology, the tab 200 can be folded along an edge of the unsealed portion 130 in some applications, so that the length of the pouch cell can be greatly reduced, thereby improving the energy density of the pouch cell.

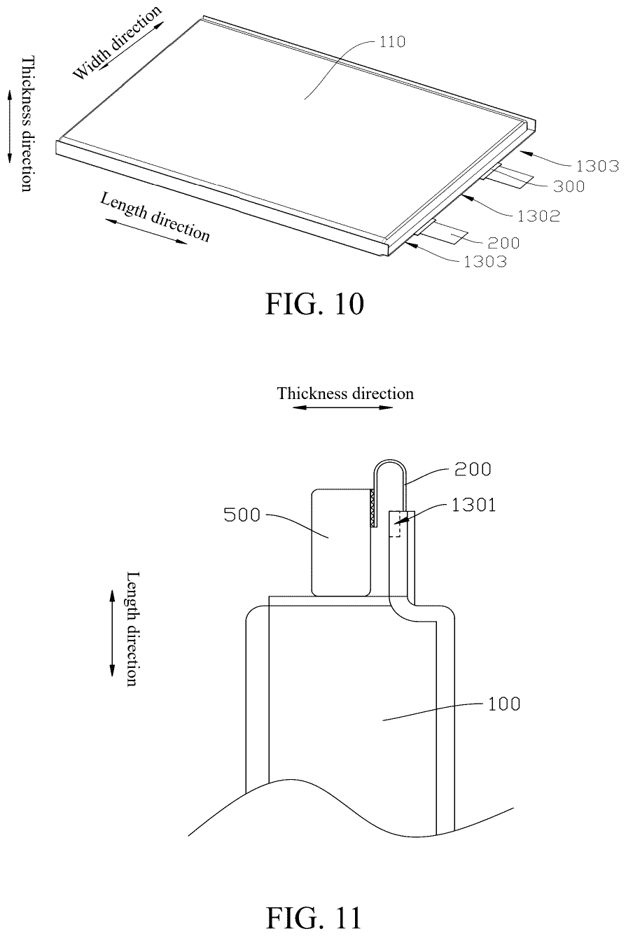

Refer to FIG. 10. FIG. 10 is a schematic structural diagram of a fourth pouch cell according to an embodiment of the first aspect of the present disclosure. In some embodiments, the first unsealed sub-portion 131 is provided with a plurality of clearance grooves 1301. The pouch cell includes a plurality of tabs 200. The plurality of clearance grooves 1301 are provided in one-to-one correspondence with the plurality of tabs 200. A region of the unsealed portion 130 located between neighboring clearance grooves 1301 is provided with a fifth notch 1302 running therethrough in the thickness direction of the unsealed portion 130. The fifth notch extends to the edge of the unsealed portion 130 and extends to the clearance grooves 1301. In the length direction of the top sealing edge 101, the two outermost clearance grooves 1301 are outer clearance grooves, and a region of the unsealed portion 130 extending outward away from each of the two outer clearance grooves is further provided with a sixth notch 1303 running therethrough in the thickness direction of the unsealed portion 130. Each sixth notch 1303 extends to the edge of the unsealed portion 130 and extends to the outer clearance grooves adjacent thereto. In other words, only the insulating layers of the unsealed portion 130 that correspond to the tabs 200 (the second insulating layer 1313 of the first unsealed sub-portion 131 and the fourth insulating layer 1323 of the second unsealed sub-portion 132, i.e., corresponding to the PP layer) are retained, so that the weight of the pouch cell is reduced. In addition, because the second insulating layer 1313 and the fourth insulating layer 1323 are each made of a soft material, the tab 200 can be folded along the edge of the sealed portion 120, so that the length of the pouch cell can be reduced, thereby improving the energy density of the pouch cell.

In some embodiments, a dimension of the unsealed portion 130 in the width direction of the top sealing edge 101 is defined as L₃, a dimension of the clearance groove 1301 in the width direction of the top sealing edge 101 is defined as L₄, and 7/8≤L₄/L₃≤9/10. It can be understood that a larger dimension of the clearance groove 1301 in the width direction of the top sealing edge 101 indicates a smaller length of the pouch cell after the tabs 200 are bent. However, a larger clearance groove 1301 indicates that the side wall of the clearance groove 1301 is closer to the sealed portion 120, leading to a risk of the sealed portion 120 being unintentionally cut. Based on this, in this embodiment, the dimension of the clearance groove 1301 in the length direction of the top sealing edge 101 is set in an appropriate range such that the dimension of the clearance groove 1301 accounts for 7/8 to 9/10 of the dimension of the first unsealed sub-portion 131 in the length direction of the top sealing edge 101, so that the risk of unintentionally cutting the sealed portion 120 can be reduced while reducing the length of the pouch cell as much as possible.

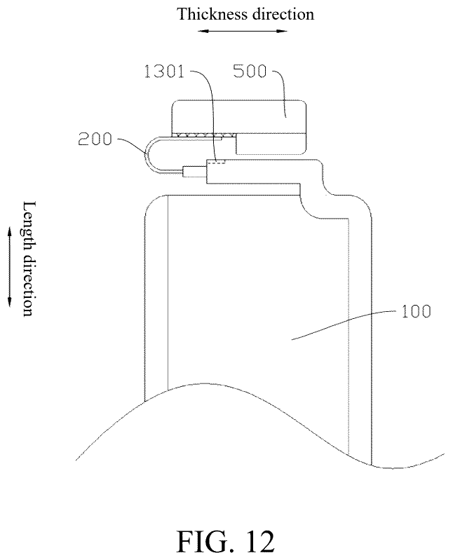

Refer to FIG. 11 and FIG. 12. FIG. 11 is a schematic structural diagram of a first battery assembly according to an embodiment of a second aspect of the present disclosure. FIG. 12 is a schematic structural diagram of a second battery assembly according to an embodiment of the second aspect of the present disclosure. The battery assembly according to the embodiments of the second aspect of the present disclosure includes a circuit board 500 and the pouch cell of the embodiments of the first aspect of the present disclosure. The first tab portion 210 is arranged to be bent toward the top sealing edge 101 and is electrically connected to the circuit board 500. A part of a projection of the first tab portion 210 in the thickness direction of the top sealing edge 101 is located in the clearance groove 1301. This reduces the risk of contact between the tab 200 and the first unsealed sub-portion 131 during use. For example, in some embodiments, when the top sealing edge 101 is not folded, i.e., when the width direction of the top sealing edge 101 corresponds to the length direction of the pouch cell, the space occupied by the first tab portion 210 and the space occupied by the unsealed portion 130 in the width direction of the top sealing edge 101 partially overlap, so that the space occupied by the pouch cell in the length direction of the pouch cell can be reduced (as shown in FIG. 11). In some embodiments, the top sealing edge 101 is bent toward the package body 110 so that the width direction of the top sealing edge 101 corresponds to the thickness direction of the pouch cell, the circuit board 500 includes two connecting surfaces 510 opposite to each other in the length direction of the pouch cell, and the first tab portion 210 is bent toward the clearance groove 1301 and is connected to any of the connecting surfaces 510. Because the clearance groove 1301 and the space occupied by the first tab portion 210 in the width direction of the top sealing edge 101 overlap, i.e., the clearance groove 1301 and the space occupied by the first tab portion 210 in the thickness direction of the pouch cell partially overlap, the space occupied by the pouch cell in the thickness direction of the pouch cell is reduced (as shown in FIG. 12). It can be seen that when the top sealing edge 101 is arranged to be bent toward the package body 110, the arrangement of the clearance groove 1301 can reduce the dimension of the battery assembly in the thickness direction of the pouch cell, thereby improving the energy density of the battery assembly of this embodiment.

It should be noted that because the pouch cell of the embodiments of the first aspect is used in this embodiment, this embodiment has all the beneficial effects brought by the embodiments of the first aspect, which will not be repeatedly described herein.

Refer to FIG. 12. FIG. 12 is a schematic structural diagram of a third battery assembly according to an embodiment of the second aspect of the present disclosure. In some embodiments, the first tab portion 210 is bent to form a bending portion 211, and the first tab portion 210 includes a plurality of bending portions 211. In other words, in this embodiment, the first tab portion 210 is bent multiple times to form a plurality of bending portions 211, so that the overall length of the battery assembly can be further reduced, thereby improving the energy density of the battery assembly.

In some embodiments, the first tab portion 210 is spaced apart from the side wall of the clearance groove 1301 in the width direction of the top sealing edge 101. For example, a spacing between the first tab portion 210 and the side wall of the clearance groove 1301 in the width direction of the top sealing edge 101 is defined as L₃, and 0<L₃≤2 mm, to improve the safety of the pouch cell. It can be understood that the risk of short circuit due to the first tab portion 210 coming into contact with the side wall of the clearance groove 1301 can be reduced by arranging the first tab portion 210 to be spaced apart from the side wall of the clearance groove 1301 in the width direction of the top sealing edge 101, but an excessive spacing also means a decrease in the overlapping area between the first tab portion 210 and the unsealed portion 130, leading to an increase in the space occupied by the entire battery assembly. Therefore, in this embodiment, the spacing between the first tab portion 210 and the side wall of the clearance groove 1301 is set within an appropriate range, i.e., the range of greater than 0 and less than or equal to 2 mm, so that the energy density of the battery assembly can be increased while improving the safety of the battery assembly.

An embodiment of a third aspect of the present disclosure provides an electrical device. The electrical device is, for example, an electronic device such as a mobile phone, a watch, or a tablet, or a vehicle such as an electric vehicle or a gas-electric hybrid vehicle. The electrical device includes the battery assembly of the embodiments of the second aspect. The first unsealed sub-portion 131 of the battery assembly is provided with the clearance groove 1301. The dimension of the first tab portion 210 in the length direction of the top sealing edge 101 is not greater than the dimension of the clearance groove 1301 of the pouch cell in the length direction of the top sealing edge 101. The first tab portion 210 is arranged to be bent toward the first unsealed sub-portion 131, so that a part of a projection of the first tab portion 210 in the thickness direction of the top sealing edge 101 is located within the range of the clearance groove 1301, thereby reducing the risk of the tab 200 coming into contact with the first unsealed sub-portion 131 during use. It can be understood that compared with the existing technology, in this embodiment, a part of the projection of the first tab portion 210 is located within the range of the clearance groove 1301, i.e., the space occupied by the first tab portion 210 and the space occupied by the unsealed portion 130 in the width direction of the top sealing edge 101 partially overlap, so that the space occupied by the pouch cell is reduced, thereby increasing the energy density of the battery assembly and improving the battery life of the electrical device.

The embodiments of the present disclosure have been described in detail above with reference to the accompanying drawings. However, the present disclosure is not limited to the foregoing embodiments. Various modifications may be made by those having ordinary skills in the art within the scope of their general knowledge without departing from the protection scope of the present disclosure. In the description of the specification, the description with reference to the terms “an embodiment,” “some embodiments,” “exemplary embodiment” “example,” “specific example”, or “some examples” and so on means that specific features, structures, materials or characteristics described in connection with the embodiment or example are embraced in at least one embodiment or example of the present disclosure. In this specification, exemplary descriptions of the foregoing terms do not necessarily refer to the same embodiment or example. Moreover, the described specific features, structures, materials, or characteristics may be combined in any suitable manner in one or more embodiments.

What is claimed is:

1. A pouch cell, comprising:
a casing, comprising a package body and a top sealing edge, wherein the package body is provided with an accommodating cavity, the top sealing edge comprises a sealed portion and an unsealed portion, the sealed portion is connected to the package body, the unsealed portion is connected to a side of the sealed portion facing away from the package body, the unsealed portion comprises a first unsealed sub-portion and a second unsealed sub-portion distributed in a thickness direction of the unsealed portion, the first unsealed sub-portion is provided with a clearance groove, and the clearance groove extends to a surface of the first unsealed sub-portion facing away from the sealed portion;
an electrode assembly, located in the accommodating cavity; and
a plurality of tabs, connected to the electrode assembly, and extending out of the accommodating cavity from between the first unsealed sub-portion and the second unsealed sub-portion, wherein a portion of each of the tabs located outside the first unsealed sub-portion and the second unsealed sub-portion is a first tab portion, and a dimension of the first tab portion in a length direction of the top sealing edge is not greater than a dimension of the clearance groove in the length direction of the top sealing edge.

2. The pouch cell of claim 1, wherein a portion of each of the tabs between the first unsealed sub-portion and the second unsealed sub-portion is a second tab portion, and a projection of the second tab portion in a thickness direction of the top sealing edge is located within a range of the clearance groove.

3. The pouch cell of claim 2, further comprising a first insulating adhesive layer located in the clearance groove and covering the second tab portion.

4. The pouch cell of claim 3, wherein the first unsealed sub-portion comprises a first insulating layer, a first metal layer, and a second insulating layer adhered to each other in a thickness direction of the first unsealed sub-portion, the first insulating layer is provided with a first notch, the first metal layer is provided with a second notch aligned with the first notch, the clearance groove comprises the first notch and the second notch, and a portion of the second insulating layer corresponding to the second notch forms the first insulating adhesive layer.

5. The pouch cell of claim 4, wherein the second unsealed sub-portion comprises a third insulating layer, a second metal layer, and a fourth insulating layer adhered to each other in a thickness direction of the second unsealed sub-portion, the third insulating layer is provided with a third notch at a position corresponding to the second tab portion, the second metal layer is provided with a fourth notch aligned with the third notch, and the fourth insulating layer covers the second tab portion.

6. The pouch cell of claim 4, wherein the first unsealed sub-portion is provided with a plurality of clearance grooves, the plurality of clearance grooves are provided in one-to-one correspondence with the plurality of tabs, a region of the unsealed portion located between neighboring clearance grooves is provided with a fifth notch running therethrough in the thickness direction of the unsealed portion, and the fifth notch extends to an edge of the unsealed portion and extends to the clearance grooves; and
in the length direction of the top sealing edge, two outermost clearance grooves of the plurality of clearance grooves are outer clearance grooves, a region of the unsealed portion extending outward away from each of the two outer clearance grooves is further provided with a sixth notch running therethrough in the thickness direction of the unsealed portion, and each sixth notch extends to the edge of the unsealed portion and extends to the outer clearance grooves adjacent thereto.

7. The pouch cell of claim 2, wherein a dimension of the unsealed portion in a width direction of the top sealing edge is defined as L₃, a dimension of the clearance groove in the width direction of the top sealing edge is defined as L₄, and 7/8≤L₄/L₃≤9/10.

8. A battery assembly, comprising:
a circuit board; and
the pouch cell of claim 1, wherein the first tab portion is arranged to be bent toward the top sealing edge and is electrically connected to the circuit board, and a part of a projection of the first tab portion in the thickness direction of the top sealing edge is located in the clearance groove.

9. The battery assembly of claim 8, wherein the top sealing edge is arranged to be bent toward the package body, the circuit board comprises two connecting surfaces opposite to each other in the length direction of the pouch cell, and the first tab portion is connected to any of the connecting surfaces.

10. The battery assembly of claim 8, wherein the first tab portion is bent to form a plurality of bending portions.

11. The battery assembly of claim 8, wherein the first tab portion is spaced apart from a side wall of the clearance groove in a width direction of the top sealing edge.
